(19) United States
(12) Patent Application Publication
(10) Pub. No.: US 2009/0055273 A1
(43) Pub. Date: Feb. 26, 2009

(54) METHOD OF PROVIDING ADVERTISING INFORMATION, SYSTEM FOR PROVIDING ADVERTISING INFORMATION, AND PROGRAM FOR PROVIDING ADVERTISING INFORMATION

(75) Inventor: Gen Miyazawa, Tokyo (JP)

Correspondence Address: DITTHAVONG MORI & STEINER, P.C., 918 Prince St., Alexandria, VA, 22314, US

(73) Assignee: CIRIUS TECHNOLOGIES, INC., Tokyo (JP)

(21) Appl. No.: 12/256,760

(22) Filed: Oct. 23, 2008

Related U.S. Application Data
(63) Continuation of application No. PCT/JP2007/071193, filed on Oct. 31, 2007.

(30) Foreign Application Priority Data
Nov. 8, 2006 (JP) 2006-302296

(51) Int. Cl. G06Q 30/00

(52) U.S. Cl. 705/14

(57) ABSTRACT

A method of providing advertising information to a communication terminal includes acquiring location information from the communication terminal and extracting advertising information of advertisers which locate within a predetermined range from a base point corresponding to the location information. The extracted advertising information is provided to the communication terminal.

### CROSS-REFERENCE TO RELATED APPLICATIONS

This application is a continuation application of PCT/JP2007/071193, filed Oct. 31, 2007, which claims priority to Japanese Patent Application No. 2006-302296, filed Nov. 8, 2006. The contents of these applications are incorporated herein by reference in their entirety.

### BACKGROUND OF THE INVENTION

1. Field of the Invention

The present invention relates to a method of providing advertising information, a system for providing advertising information, and a program for providing advertising information.

2. Discussion of the Background

Recently, wireless communication terminals have been widely used for use in wireless communications. Specifically, the use of mobile telephone terminals that function as telephones has become significantly widespread due to the convenience of easy incoming and outgoing calls regardless of location or time as well as sophisticated functions, reduced prices, and broadened call-enabled areas. In particular, mobile telephone terminals capable of transmitting/receiving information such as e-mails and configured with GPS (Global Positioning System) capable of transmitting/receiving location information have become the recent mainstream. Herein, a terminal refers to a terminal device.

As with personal computers (hereinafter referred to as “PCs”), most of the recent mobile telephone terminals have Internet access. These PCs and mobile telephone terminals with Internet access generally carry a Web browser, making it possible to access various Internet sites via the Internet.

For example, various information related to search keywords can also be obtained by accessing search sites that enable searches using keywords through a search engine and by entering search keywords. Furthermore, for example, daily news information can also be obtained by accessing news distribution sites run and managed by newspaper companies.

As described above, with the spread of access to Internet sites using communication terminals such as PCs and mobile telephone terminals, Internet sites have attracted attention and been widely used as new advertising media. For example, advertising panes are provided on parts of site pages of the search sites and news distribution sites described above and advertising information is posted within these panes, thereby enabling the advertising information to be viewed by many Internet users and resulting in highly effective advertising.

Recently, more effective advertising information has been selectively displayed for Internet site audiences (users) to generate highly effective advertising. For example, based on a keyword that has been entered into a search site, advertising information highly relevant to the keyword is displayed together with the search results (e.g., see Japanese Unexamined Patent Application Publication No. 2003-196509, PCT Application No. 2003-501729, PCT Application No. 2005-533327, and PCT Application No. 2006-500699). In this way, advertising information relevant to a keyword that a user is highly interested in is selectively displayed, and therefore the user will take a high interest in the advertising information as well. As a result, the displayed advertising information will contain advertising that is highly appealing and effective for the user.

In addition, with the use of location-tracking systems such as GPS, services for accurately determining the location of a mobile telephone terminal (or a user thereof) have been provided. For example, even when one is at an unknown location where it is difficult to understand the circumstances, these services make it possible to quickly understand the circumstances by acquiring information regarding one's own location using a mobile telephone terminal (e.g., see Japanese Unexamined Patent Application Publication No. 2001-306567, Japanese Unexamined Patent Application Publication No. 2003-044552, and Japanese Unexamined Patent Application Publication No. 2004-310524).

The contents of Japanese Unexamined Patent Application Publication No. 2003-196509 are incorporated herein by reference in their entirety. The contents of PCT Application No. 2003-501729 and its Published Japanese Translation, PCT Application No. 2005-533327 and its Published Japanese Translation, PCT Application No. 2005-537591 and its Published Japanese Translation, and PCT Application No. 2006-500699 and its Published Japanese Translation are incorporated herein by reference in their entirety. The contents of Japanese Unexamined Patent Application Publication No. 2001-306567, Japanese Unexamined Patent Application Publication No. 2003-044552, and Japanese Unexamined Patent Application Publication No. 2004-310524 are incorporated herein by reference in their entirety.

However, advertising information containing highly effective advertising for users may not be provided even if a search keyword is entered into a search site. For example, when a specific regional name is input as a search keyword into a search site on which advertising panes have been established, advertising information regarding the specific region is provided but advertising information regarding areas adjacent to the region is not provided.

As an example, when a user enters “Dogenzaka, Shibuya-ku”/“noodle shops” as search keywords, advertising information regarding noodle shops located in Dogenzaka, Shibuya-ku is provided. However, advertising information regarding noodle shops located in “Shinsen-cho, Shibuya-ku”, which is adjacent to “Dogenzaka, Shibuya-ku”, is not provided.

In this case, it may be more useful for the user to obtain broad-ranging advertising information regarding noodle shops in “Dogenzaka, Shibuya-ku and the vicinity” without limiting the location to “Dogenzaka, Shibuya-ku”. Therefore, information regarding noodle shops in “Shinsen-cho, Shibuya-ku”, which is adjacent to “Dogenzaka, Shibuya-ku”, may also be advertising information useful for the user. However, even when the search keywords “Dogenzaka, Shibuya-ku”/“noodle shops” are used, advertising information regarding noodle shops in “Shinsen-cho, Shibuya-ku” is not provided, thus failing to provide advertising information useful for the user.

Needless to say, when the keywords “Shinsen-cho, Shibuya-ku”/“noodle shops” are input, advertising information regarding noodle shops in Shinsen-cho, Shibuya-ku can be obtained, but this fails to provide advertising information regarding noodle shops in Dogenzaka, Shibuya-ku. If complicated search formulas such as “‘Dogenzaka, Shibuya-ku’ & ‘noodle shops’ or ‘Shinsen-cho, Shibuya-ku’ & ‘noodle shops’” are created, advertising information regarding noodle shops in both Dogenzaka and Shinsen-cho can be obtained, but this is highly bothersome for users.

Furthermore, it is very convenient if advertising information regarding the vicinity of the location of the user is obtained. For example, if advertising information regarding noodle shops located in “Dogenzaka, Shibuya-ku” or “Shinsen-cho, Shibuya-ku” is obtained when a user enters “noodle shops” as a search keyword and is in an area near the boundary of “Dogenzaka, Shibuya-ku” and “Shinsen-cho, Shibuya-ku”, not only is it very convenient and useful for users, but advertisers can easily obtain highly effective advertising.

The present invention has been made in view of the above situation and addresses the exemplary problems to provide a method of providing advertising information, a system for providing advertising information, and a program for providing advertising information that enable users to be provided with broad-ranging advertising information from the vicinity that is useful for users and can contribute to highly effective advertising for an advertiser by utilizing location information without regard to place names.

### SUMMARY OF THE INVENTION

According to one aspect of the present invention, a method of providing advertising information to a communication terminal includes acquiring location information from the communication terminal and extracting advertising information of advertisers which locate within a predetermined range from a base point corresponding to the location information. The extracted advertising information is provided to the communication terminal.

According to another aspect of the present invention, a system for providing advertising information includes a place-name database, an advertising database, a predetermined-information-acquiring part, a place-name-extracting part, a location-information-extracting part, an advertising-information-extracting part, and an advertising-information-providing part. The place-name database is constructed by associating place-name information with location information that indicates a specific place corresponding to the place-name information. The advertising database is constructed by associating advertising information with location of an advertiser that corresponds to the advertising information. The predetermined-information-acquiring part is configured to acquire predetermined information that has been input through a communication terminal. The place-name-extracting part is configured to extract the place-name information from the predetermined information. The location-information-extracting part is configured to extract from the place-name database the location information that has been associated with the place-name information. The advertising-information-extracting part is configured to extract from the advertising database the advertising information of the advertiser located within a predetermined range from a base point corresponding to the location information. The advertising-information-providing part is configured to provide the extracted advertising information to the communication terminal.

According to further aspect of the present invention, a program for providing advertising information causes a computer to function as a predetermined-information-acquiring part, a place-name-extracting part, a location-information-extracting part, an advertising-information-extracting part, and an advertising-information-providing part. The predetermined-information-acquiring part acquires predetermined information that has been input through a communication terminal. The place-name-extracting part extracts place-name information from the predetermined information. The location-information-extracting part extracts location information that has been associated with the place-name information. The advertising-information-extracting part extracts advertising information of the advertiser located within a predetermined range while using the location corresponding to the location information as a base point of the predetermined range. The advertising-information-providing part provides the extracted advertising information to the communication terminal.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic block diagram illustrating the overall constitution of an advertising system that includes the system for providing advertising information that implements the method of providing advertising information, according to an embodiment of the present invention;

FIGS. 2A and 2B are explanatory diagrams illustrating a state in which the search site page is displayed on the display of the mobile telephone terminal shown in FIG. 1, wherein FIG. 2A shows a state before the search keyword is input and FIG. 2B shows a state in which the search results and advertising information are displayed;

FIG. 3 is a block diagram illustrating an outline of the internal constitution of the advertising management server shown in FIG. 1;

FIG. 4 is a block diagram illustrating an outline of the internal constitution of the database server shown in FIG. 1;

FIG. 5 is a structural diagram illustrating the data structure of the place-name database in the database shown in FIG. 4;

FIG. 6 is a structural diagram illustrating the data structure of the advertising database in the database shown in FIG. 4;

FIG. 7 is a graph showing the correlation between the advertising rate CPC and distance L;

FIG. 8 is a graph showing the correlation between the expected click value CTR and distance L;

FIG. 9 is a flowchart describing the procedure for implementing the method of providing advertising information according to the embodiment of the present invention and showing a case in which place-name information is included in the search keyword;

FIG. 10 is a flowchart describing the procedure for implementing the method of providing advertising information according to the embodiment of the present and showing a case in which place-name information is not included in the search keyword; and

FIG. 11 is a diagram showing a state in which a map is displayed on the display of the mobile telephone terminal in the method of providing advertising information according to the embodiment of the present invention.

### DESCRIPTION OF THE EMBODIMENTS

The embodiments will now be described with reference to the accompanying drawings, wherein like reference numerals designate corresponding or identical elements throughout the various drawings.

### Embodiment 1

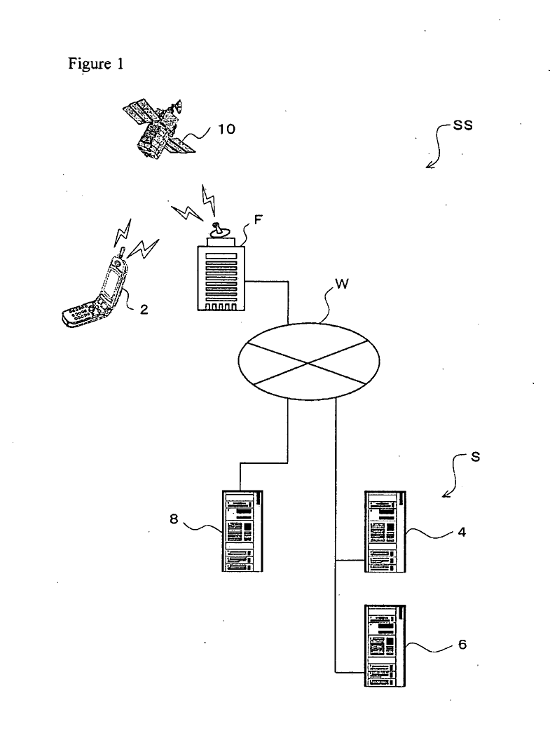

Embodiment 1 of the present invention will now be described with reference to the drawings. FIG. 1 is a schematic block diagram showing the overall constitution of an advertising system SS that includes a system for providing advertising information S, which implements the method of providing advertising information according to Embodiment 1 of the present invention. This advertising system SS includes the system for providing advertising information S, a base station F, a mobile telephone terminal (communication terminal) 2, a search site server 8, and the Internet W, and the system for providing advertising information S is configured with an advertising management server 4 and a database server 6.

The advertising management server 4 includes a predetermined-information-acquiring part, a place-name-extracting part, a location-information-extracting part, an advertising-category-information-extracting part, an advertising-information-extracting part, a ranking-information-generating part, and an advertising-information-providing part, and the database server 6 includes a location database and an advertising database, the details of which are described below. In Embodiment 1, the mobile telephone terminal 2 is described as an example of the communication terminal, but the communication terminal may be a different device so long as it is a terminal device capable of transmitting/receiving information to/from the advertising management server 4. For example, it may be a PC connected to the advertising management server 4 via the Internet W.

The base station F is used for wireless communications with the mobile telephone terminal 2. The base station F is configured to be connected to a telephone network (not shown) to implement a telephone call by the mobile telephone terminal 2 and to be connected to the Internet W so that Internet access using the mobile telephone terminal 2 is implemented. Therefore, it includes functions capable of receiving information transmitted from the mobile telephone terminal 2 to transmit it to the advertising management server 4 via the Internet W, as well as receiving information from the advertising management server 4 to transmit it to the mobile telephone terminal 2 via the Internet W. It also includes a function capable of receiving location information from the mobile telephone terminal 2 to transmit it to the advertising management server 4.

In the event that a PC is used as the communication terminal instead of the mobile telephone terminal 2, the advertising system SS does not need to include the base station F because the PC is directly connected to the Internet W.

The mobile telephone terminal 2 includes a function that enables telephone calls and Internet access and is configured to transmit/receive information to/from the advertising management server 4 and search site server 8, which have been connected to the Internet W through the base station F. Furthermore, it also includes a GPS (Global Positioning System) function that enables the acquisition of its own location information (terminal-location information) 2p using a GPS satellite 10. This terminal-location information 2p is transmitted from the mobile telephone terminal 2 to the base station F or transmitted directly from the GPS satellite 10 to the base station F.

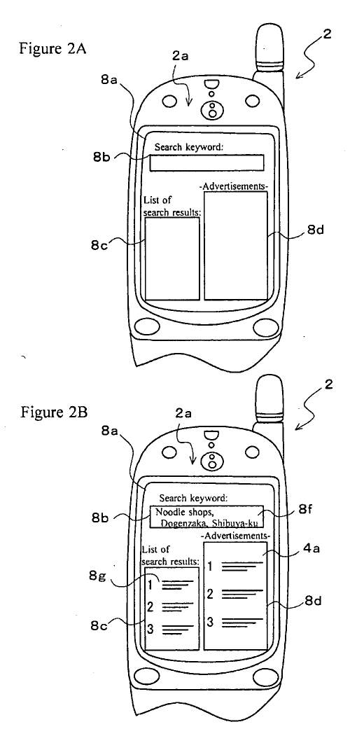

FIG. 2A is an explanatory diagram illustrating a state in which search site page 8a of the search site server 8 is displayed on a display 2a of the mobile telephone terminal 2. Once connecting to the search site server 8 using the Internet access function, the search site page 8a will be displayed on the display 2a of the mobile telephone terminal 2. This search site page 8a is provided with a search-keyword input pane 8b, a search-results display pane 8c, and an advertising-information display pane 8d.

Once a search keyword (predetermined information) 8f is input into the search-keyword input pane 8b, the search keyword 8f is transmitted to the search site server 8 via the Internet W. Subsequently, information is retrieved in accordance with the search keyword 8f in the search site server 8 and the search results 8g are transmitted to the mobile telephone terminal 2.

FIG. 2B is an explanatory diagram illustrating a state in which the search results 8g are displayed on the display 2a of the mobile telephone terminal 2. Once the search results 8g are transmitted to the mobile telephone terminal 2 from the search site server 8, the search results 8g are displayed on the search-results display pane 8c as shown in FIG. 2B. Simultaneously, advertising information 4a that has been extracted in accordance with the search keyword 8f is also displayed on the advertising-information display pane 8d.

The mobile telephone terminal 2 includes a function of determining its own location information (terminal-location information) 2p. For example, the function of determining location information may be one using the GPS satellite 10 for determination or may be one using information transmission/reception from among a plurality of the base stations F to determine location. In addition, it also includes a function of transmitting the determined terminal-location information 2p to the base station F. At the same time, information regarding the time (tm) when its terminal-location information 2p was determined is also transmitted to the base station F.

The search site server 8 is a server computer connected to the Internet W and provides search services using search engines. The search site server 8 includes a function that allows the display 2a of the mobile telephone terminal 2 that has accessed the server to display the search site page 8a, a function of searching for information in accordance with the search keyword 8f that has been input into the search-keyword input pane 8b on the search site page 8a, and a function of transmitting the search results 8g to the mobile telephone terminal 2. It also includes a function of transmitting the search keyword 8f that has been input into the search-keyword input pane 8b to the advertising management server 4 via the Internet W.

The advertising management server (computer) 4 is a server computer for providing advertising information to the mobile telephone terminal 2 via the Internet W and is connected to both the Internet W and the database server 6.

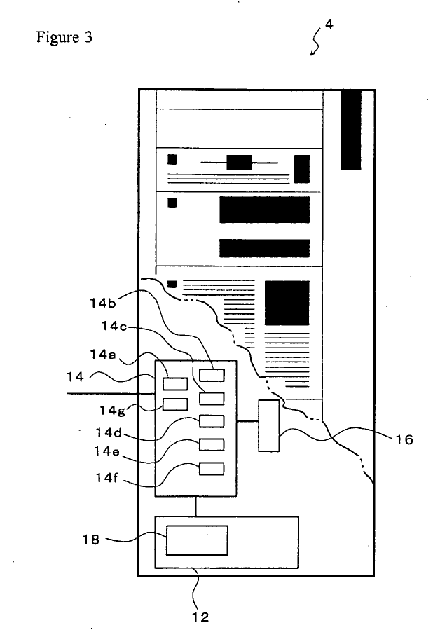

FIG. 3 is a block diagram illustrating an outline of the internal constitution of the advertising management server 4. The advertising management server 4 includes a storage device 12, a CPU 14 as a main part of the computer, and a main memory 16 in the inside thereof. The storage device 12 is, for example, a data storage means such as hard disks and contains a program for providing advertising information 18 in the inside thereof.

The program for providing advertising information 18 is a program for causing the advertising management server 4 or CPU 14 as the main part to function as the predetermined-information-acquiring part 14a, place-name-extracting part 14b, location-information-extracting part 14c, advertising-category-information-extracting part 14d, advertising-information-extracting part 14e, ranking-information-generating part 14f, and advertising-information-providing part 14g. Each function of the CPU 14 exercised by this program for providing advertising information 18 will be described below.

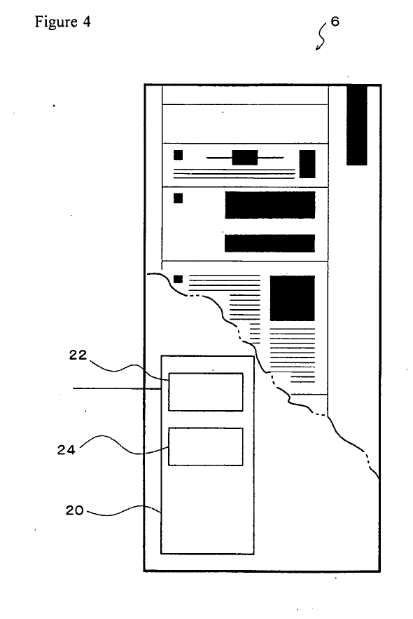

FIG. 4 is a block diagram illustrating an outline of the internal constitution of the database server 6. The database server 6 includes a storage device 20 in the inside thereof. The description of the constitution of the storage device 20 will be omitted because it is similar to that of the storage device 12. A place-name database 22 and an advertising database 24 are stored in the inside of the storage device 20. In Embodiment 1 of the present invention, the advertising management server 4 and database server 6 have been described as different servers, but of course, one server may include the functions of both the advertising management server 4 and database server 6.

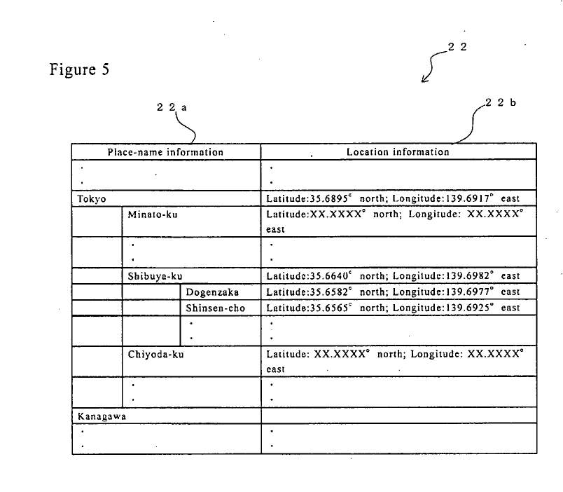

The place-name database 22 is a database configured by associating place-name information with location information that indicates a specific place corresponding to the place-name information. FIG. 5 is a structural diagram illustrating the data structure of the place-name database 22.

The place-name database 22 includes place-name information 22a as its internal data. The place-name information 22a is information equivalent to address representations such as “Tokyo” and “Minato-ku”, but it may be information equivalent to landmarks such as “Tokyo Tower” and “Yokohama station”. Location information 22b is associated with each piece of place-name information 22a. This location information 22b is information indicating a specific place corresponding to the place-name information 22a and is configured to include so-called GPS information comprising, for example, latitudinal and longitudinal information.

More specifically, the place-name information 22a for “Tokyo” is associated with 35.6895° north latitude (latitude: 35°41′22″N) and 139.6917° east longitude (longitude: 139°41′30″E), which is the GPS information for Tokyo Metropolitan Government, as the location information 22b. The place-name information 22a for “Shibuya-ku” is associated with 35.6640° north latitude and 139.6982° east longitude, which is the GPS information for the Shibuya Ward Office, as the location information 22b. Similarly, the place-name information 22a for “Dogenzaka” is associated with 35.6582° north latitude and 139.697° east longitude as the location information 22b that indicates a specific place in Dogenzaka, Shibuya-ku, and the place-name information 22a for “Shinsen-cho” is associated with 35.6565° north latitude and 139.6925° east longitude as the location information 22b that indicates a specific place in Shinsen-cho, Shibuya-ku.

As described above, in the place-name database 22, place-name information 22a equivalent to address representations or landmarks in Japan or other countries is associated with GPS information as location information 22b corresponding to its place-name information 22a.

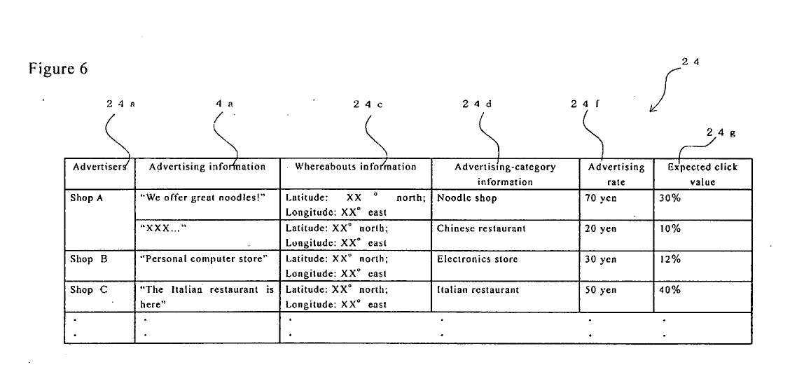

The advertising database 24 is a database configured by associating advertising information with information on an advertiser's whereabouts corresponding to the advertising information. In the advertising database 24, advertising-category information, advertising rates, and expected click values are also associated with the advertising information. FIG. 6 is a structural diagram illustrating the data structure of the advertising database 24.

The advertising database 24 contains the advertising information 4a as its internal data. The advertising information 4a is provided by an advertiser 24a to communication terminals such as the mobile telephone terminal 2 and PCs via the Internet W and is configured with, for example, phrases such as “We offer great noodles” as shown in FIG. 6.

Whereabouts information 24c is location information for identifying the location of the advertiser 24a providing the advertising information 4a and is configured with, for example, GPS information indicating the location of the advertiser 24a.

The advertising-category information 24d is classified information regarding the contents of advertising allocated for each piece of advertising information 4a. Examples of the advertising-category information 24d include “restaurants”, “electronics stores”, “pet shops”, “discount stores”, “convenience-stores”, and the like. Furthermore, the advertising-category information 24d may include sub-classification information such as “Japanese restaurants”, “noodle shops”, and “Italian restaurants” under the larger classification information “restaurants”.

The advertising rate 24f is the price of services committed to be paid by the advertiser 24a to a party who runs and manages the system for providing advertising information S, more specifically an advertising agent for the services for providing the advertising information 4a, and is predetermined by each piece of advertising information. In this advertising rate 24f, payment may be made every time the advertising information 4a is provided to a mobile telephone terminal 2, or payment may be made every time the advertising information 4a displayed on the display 2a of a mobile telephone terminal 2 is selected by a user and the detailed information is viewed.

The expected click value 24g is information indicating the probability that the detailed information will be viewed when the advertising information 4a is displayed on the display 2a of the mobile telephone terminal 2. More specifically, it is a rate calculated by the number of times a piece of advertising information 4a is selected to view detailed information by an interested user divided by the number of times the piece of advertising information 4a is provided, and it is correlated with the popularity and effectiveness of the advertising information 4a.

As described above, in the advertising database 24, the advertiser 24a, the advertising information 4a, the whereabouts information 24c of the advertiser, the advertising-category information 24d, the advertising rate 24f, and the expected click value 24g are associated with each other.

The CPU 14 is a main part of this advertising management server 4 and performs various arithmetic processes in cooperation with the storage device 12 and main memory 16. The CPU 14 fulfills the functions of the predetermined-information-acquiring part 14a, the place-name-extracting part 14b, the location-information-extracting part 14c, the advertising-category-information-extracting part 14d, the advertising-information-extracting part 14e, the ranking-information-generating part 14f, and the advertising-information-providing part 14g in accordance with instructions from the program for providing advertising information 18. It also fulfills the function of acquiring terminal-location information 2p transmitted from the mobile telephone terminal 2 or base station F and the time when the terminal-location information (the time when the terminal-location information was determined) tm was determined.

The predetermined-information-acquiring part 14a includes a function of acquiring the search keyword 8f as predetermined information that has been input through the mobile telephone terminal 2 from the search site server 8 via the Internet W. The predetermined-information-acquiring part 14a may be, of course, configured to directly acquire the search keyword 8f from the mobile telephone terminal 2 via the Internet W instead of from the search site server 8.

The place-name-extracting part 14b includes a function of extracting the place-name information 22a from the obtained search keyword 8f. For example, when the search keyword 8f is “noodle shops, Dogenzaka, Shibuya-ku”, the phrase “Dogenzaka, Shibuya-ku” from this search keyword 8f is recognized and extracted as the place-name information 22a.

The location-information-extracting part 14c includes a function of extracting the location information 22b associated with the place-name information 22a from the place-name database 22 in accordance with the place-name information 22a extracted from the search keyword 8f. For example, when the extracted place-name information 22a is “Dogenzaka”, the information “latitude: 35.6582° north; longitude: 139.6977° east” is extracted as the location information 22b associated with “Dogenzaka” from the place-name database 22.

The advertising-category-information-extracting part 14d includes a function of extracting the advertising-category information 24d from the search keyword 8f. For example, when the search keyword 8f is “noodle shops, Dogenzaka, Shibuya-ku”, the phrase “noodle shops” from this search keyword 8f is recognized and extracted as the advertising-category information 24d.

The advertising-information-extracting part 14e includes a function of extracting from advertising database 24 the advertising information 4a of an advertiser 24a located within a predetermined range while using the location corresponding to the location information 22b as a base point. Herein, for example, the predetermined range means includes distances from the location corresponding to the location information 22b that are within a 100-meter radius or within a 500-meter radius.

For example, while the location corresponding to “latitude: 35.6582° north; longitude: 139.6977° east” extracted as the location information 22b that corresponds to the place-name information 22a for “Dogenzaka, Shibuya-ku” is used as a base point, an advertiser 24a with a whereabouts information 24c within a 100-meter radius from the point is selected, and the advertising information 4a of this advertiser 24a is extracted.

The advertising information 4a of the advertiser 24a within the predetermined range is extracted while using the location corresponding to the location information 22b as a base point, thereby extracting the advertising information 4a as long as it is within the predetermined range regardless of whether the address of the advertiser 24a is in “Dogenzaka, Shibuya-ku” or “Shinsen-cho, Shibuya-ku”.

In Embodiment 1 of the present invention, the predetermined range of the advertising-information-extracting part 14e has been determined in accordance with the distance from the location corresponding to the location information 22b, but it is not limited to this configuration. For example, the predetermined range may be determined in accordance with administrative units. For example, the location information 22b in the place-name database 22 may be information indicating administrative units such as “Shibuya-ku”, and the whereabouts information 24c in the advertising database 24 may also be information indicating administrative units.

According to this idea, the location-information-extracting part 14c extracts “Shibuya-ku” as the location information 22b from the place-name information 22a for “Dogenzaka, Shibuya-ku”, and the advertising-information-extracting part 14e selects the advertiser 24a for which “Shibuya-ku” is included in the whereabouts information 24c, thus making it possible to extract the advertising information 4a of the advertiser 24a. In other words, the advertising information 4a of the advertiser 24a located within the same administrative unit can be extracted regardless of the distance from the location corresponding to the location information 22b.

In this case, information indicating administrative units as the location information 22b and whereabouts information 24c may be character information such as “Shibuya-ku” or may be code information (local government codes) such as “13113”.

In addition, the predetermined range may be configured to include not only the same administrative unit but also different administrative units. For example, when “Shibuya-ku” is extracted as the location information 22b, “Minato-ku” and “Setagaya-ku”, which are adjacent to “Shibuya-ku”, may also be within the predetermined range to extract the advertising information 4a in which these administrative units are set as the whereabouts information 24c.

Furthermore, the predetermined range may be configured in accordance with a combination of the distance and administrative unit. For example, administrative units and GPS information are extracted from the place-name information 22a as the location information 22b, the location corresponding to the GPS information is set as a base point, and a range within a 500-meter radius from the point that is within “Shibuya-ku” can be the predetermined range.

The advertising-information-extracting part 14e extracts only advertising information 4a associated with the advertising-category information 24d for “noodle shops” from further extracted advertising information 4a. When the advertising-category information 24d does not have sub-classification information for “noodle shops”, only advertising information 4a associated with “restaurants”, which is its larger classification information, is extracted.

The ranking-information-generating part 14f includes a function of generating ranking information H for each piece of advertising information 4a that indicates the priority when extracted advertising information 4a is displayed on the display 2a of the mobile telephone terminal 2. The ranking information H is associated with each piece of advertising information 4a and is provided to the mobile telephone terminal 2 by the advertising-information-providing part 14g via the Internet W. Needless to say, the extracted advertising information 4a and ranking information H are associated with each other to be transmitted to the search site server 8 via the Internet W so that they can be provided together with the search results 8g from the search site server 8 to the mobile telephone terminal 2.

In accordance with the ranking information H, higher-priority advertising information 4a is given higher priority to be displayed by the mobile telephone terminal 2. Herein, “Higher priority” is a concept including “superiority”, “larger display mode”, “more emphasized display mode”, “higher frequency”, and “longer period of time”.

The ranking information H is generated in accordance with at least any one of: the advertising rate 24f for each piece of advertising information 4a; the expected click value 24g for each piece of advertising information 4a; the distance Lp from the location corresponding to the location information 22b that has been associated with the place-name information 22a to the location of the advertiser 24a; the distance Lm from the location corresponding to the terminal-location information 2p of the mobile telephone terminal 2 to the location of the advertiser 24a; and the time difference T between the time when the terminal-location information is determined (tm) (the time at which the terminal-location information 2p is determined) and the time when the advertising information is provided (ta) (the time at which the advertising information 4a will be provided to the mobile telephone terminal 2). Methods of generating the ranking information will be described below.

### Methods of Generating Ranking Information

For the descriptions of the methods for generating ranking information, the generation of ranking information H4, H5 of the advertising information 4a and advertising information 5a (not shown) is described. Herein, the advertising information 5a is associated with the advertiser 25a, the whereabouts information 25c, the advertising-category information 25d, the advertising rate 25f, and the expected click value 25g (none of which are shown).

A Method in Accordance with Advertising Rates

This is a method for determining the priority in accordance with the highness or lowness of the advertising rates 24f, 25f of the advertising information 4a, 5a. For example, when the advertising rate 24f is higher than the advertising rate 25f, the ranking information H4, H5 is generated so that the priority of the ranking information H4 of the advertising information 4a becomes higher than the ranking information H5 of the advertising information 5a.

In this case, the ranking information H4, H5 may be generated so that the priority ratio is set depending on the price ratio of the advertising rate 24f of the advertising information 4a to the advertising rate 25f of the advertising information 5a. For example, when the advertising rate 24f is 70 yen and the advertising rate 25f is 30 yen, the ranking information H4, H5 will be generated so that the priority ratio of the advertising information 4a to the advertising information 5a is 7:3.

When the priority ratio is set to 7:3, for example, in 10 instances of provision of advertising information, the advertising information 4a is preferentially provided 7 times and the advertising information 5a is preferentially provided 3 times. Alternatively, for example, in 10 minutes of provision time of advertising information, the advertising information 4a is preferentially provided for 7 minutes and the advertising information 5a is preferentially provided for 3 minutes.

In each piece of advertising information 4a, 5a, the ranking information H4, H5 can also be generated by setting a plurality of different advertising rates depending on the distance Lp so that the priority is set in accordance with the plurality of advertising rates and distance Lp. For example, for the advertising rate 24f of the advertising information 4a, an advertising rate PO for when the distance from the location corresponding to the whereabouts information 24c of the advertiser 24a to the location corresponding to the location information 22b is Lp=0 and an advertising rate P20 for when the distance Lp=20 km are preset. Herein, the price value of the advertising rate P20 is preset to be smaller than that of the advertising rate PO.

In addition, for the advertising rate 25f of the advertising information 5a, an advertising rate P6 for when the distance is Lp=0 and an advertising rate P26 for when the distance is Lp=20 km are preset. The price value of the advertising rate P26 is preset to be smaller than that of the advertising rate P6.

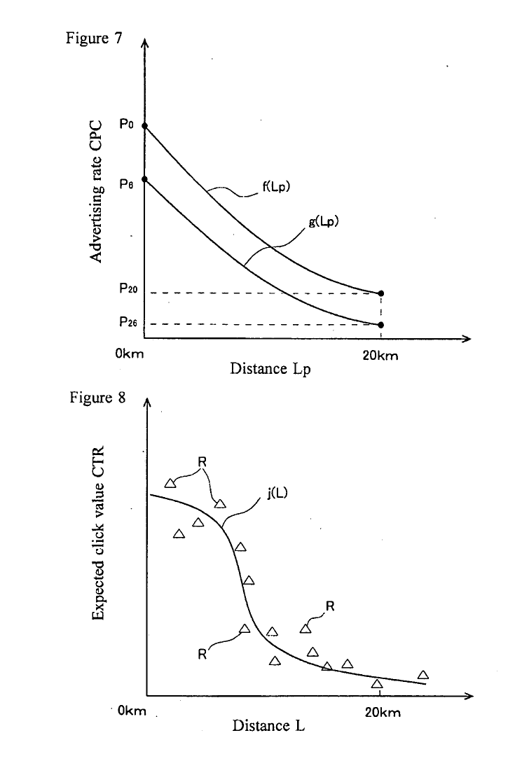

In general, the greater the distance Lp, the less effective the advertising becomes, and therefore the advertising rate CPC of the advertising information 4a is defined using a function f(Lp) and the advertising rate CPC of the advertising information 5a is defined using a function g(Lp) as shown in FIG. 7. Herein, for the advertising information 4a, the advertising rate CPC=PO when Lp=0 and the advertising rate CPC=P20 when Lp=20 km. For the advertising information 5a, the advertising rate CPC=P6 when Lp=0, and the advertising rate CPC=P26 when Lp=20 km. The ranking information H4, H5 is generated so that the priority of the advertising information 4a, 5a is set in accordance with these advertising rates CPC.

Through this configuration, the priority of advertising information can be set depending on the advertising rate, and the advertising information can be provided in a manner equitable for advertisers paying for advertising rates. Moreover, if it is configured so that an advertising rate varies depending on the distance Lp and the priority of advertising information is set depending on the advertising rate, charges of an advertising rate appropriate for the advertising effectiveness can be obtained along with provision of advertising information that is equitable for the advertising rate.

An example in which advertising rates CPC of each piece of advertising information 4a, 5a vary depending on the distance Lp has been described above, but it may be configured so that the advertising rates CPC of each piece of advertising information 4a, 5a vary depending on the distance Lm from the location corresponding to the whereabouts information 24c, 25c of the advertisers 24a, 25a to the location corresponding to the terminal-location information 2p of the mobile telephone terminal 2.

A Method in Accordance with Time Difference

The time difference T is the difference (ta-tm) between the time when advertising information is provided (ta) and the time when terminal-location information is determined (tm). More specifically, it means that a smaller time difference T results in more recent terminal-location information (tm), and therefore the probability that the mobile telephone terminal 2 is located in the vicinity of the location corresponding to the terminal-location information 2p is higher.

On the other hand, a larger time difference T means that the time when the terminal-location information is determined (tm) is earlier (i.e., a further previous time), and the probability that the mobile telephone terminal 2 is located in the vicinity of the location corresponding to the terminal-location information 2p is lower.

The time difference T is calculated in accordance with the time when the terminal-location information is determined (tm) every time the advertising management server 4 acquires the terminal-location information 2p and the time when the terminal-location information is determined (tm) from the mobile telephone terminal 2 or base station F. Subsequently, both ranking information H4, H5 are generated so that the ranking information H4 of the advertising information 4a that has been extracted in accordance with terminal-location information 2p with a small time difference T is given a higher priority over the ranking information H5 of the advertising information 5a that has been extracted in accordance with terminal-location information 2p with a large time difference T.

Through this configuration, the priority for advertising information relevant to the later time with the smaller time difference T can be set higher than the priority for advertising information relevant to the earlier time with the larger time difference T, making it possible to preferentially provide advertising information that is more useful for users and contains highly effective advertising for advertisers.

A Method in Accordance with Distance

The distance Lp refers to the distance from the location corresponding to the location information 22b that has been associated with the place-name information 22a to the location of the advertisers 24a, 25a (the locations that correspond to the whereabouts information 24c, 25c). Furthermore, the distance Lm refers to the distance from the location corresponding to the determined terminal-location information 2p to the locations of the advertisers 24a, 25a. Therefore, when the distances Lp, Lm for the advertiser 24a are smaller (closer) than the distances Lp, Lm for the advertiser 25a, the advertising information 4a will be more useful for users compared to the advertising information 5a.

Therefore, both ranking information H4, H5 are generated so that the ranking information H4 of the advertising information 24a of the advertiser 24a with the smaller distances Lp, Lm is given higher priority over the ranking information H5 of the advertising information 5a of the advertiser 25a with the larger distances Lp, Lm.

Herein, the ranking information H may be calculated with the following formula:

H=k×T×Lm (wherein k is a coefficient).

This makes it possible to generate a smaller value of ranking information of its advertising information, the smaller the time difference T is, and the smaller the distance Lm is. In this case, the smaller the value of the ranking information H is, the higher the priority is set. Thereby, the priority of the advertising information 4a of the advertiser 24a that is relevant to the later determined time (tm) of the terminal-location information 2p and is located close to the location corresponding to the terminal-location information 2p can be set high. Therefore, advertising information that is more useful for users and contains highly effective advertising for advertisers can be preferentially provided.

In addition, herein, the ranking information H may be calculated with the following formula:

H=k×(c1×T+c2×Lm) (wherein k, c1, and c2 are coefficients),

wherein c1 is a time-difference-weighting coefficient and c2 is a distance-weighting coefficient, and setting the large time-difference-weighting coefficient c1 can increase the ratio of contribution to the ranking information by the time difference T and setting the large distance-weighting coefficient 2 can increase the ratio of contribution to the ranking information by the distance Lm.
A Method in Accordance with Expected Click Values

The expected click values 24g, 25g are numerical values indicating the probability that the detailed information of the advertising information 4a, 5a will be viewed when the advertising information 4a, 5a is provided on the display 2a of the mobile telephone terminal 2. It will be understood that significantly high effectiveness of advertising will be achieved when the detailed information of the advertising information 4a, 5a is viewed compared to when only the advertising information 4a, 5a is provided on the display 2a.

Therefore, for example, by defining the expected click value 24g of the advertising information 4a as the expected probability that the detailed information of the advertising information 4a will be viewed and by estimating it in accordance with past probabilities of viewed detailed information of the advertising information 4a (i.e., the number of times that the detailed information of the advertising information 4a is viewed divided by the number of times that the advertising information 4a is provided on the display 2a), the validity of the advertising effectiveness of the advertising information 4a can be indicated.

For example, when the expected click value 24g of the advertising information 4a is 30% and the expected click value 25g of the advertising information 5a is 12%, ranking information H4, H5 are respectively generated so that the priority of the advertising information 4a is set higher than the priority of the advertising information 5a.

In addition, for example, it is also possible to further improve the ranking accuracy by further converting an expected click value CTR of certain advertising information into a function of the distance L, wherein the distance L may be either: the distance Lp between the location corresponding to the location information 22b that has been associated with the place-name information 22a if needed and the location of an advertiser; or the distance Lm between the location corresponding to the terminal-location information 2p and the location of an advertiser.

As shown in FIG. 8, the expected click value CTR, which includes a distance function, is a numerical value that changes in accordance with the distance L and can be expressed as j(L), which is a function of the distance L. In general, the expected click value CTR decreases as the distance L increases (becomes farther).

However, it is difficult to determine how much an expected click value CTR will decrease as the distance L increases due to other factors such as the popularity of the advertisers 24a, 25a and the appeal of the advertising information 4a, 5a. In addition, an expected click value CRT and the degree of its decrease may vary between each advertiser 24a, 25a. Therefore, an expected click value CTR in accordance with the distance L for each piece of the advertising information 4a, 5a is estimated by the ranking-information-generating part 14f.

This estimating calculation is performed in accordance with a learning calculation using a neural network. For example, when the advertising information 4a is provided on the display 2a of the mobile telephone terminal 2, the distance L at the time and information as to whether the detailed information of the advertising information 4a has been viewed are acquired so that data can be statistically accumulated.

This makes it possible to acquire an actual determined value for the expected click value 24g at the predetermined distance L of the advertising information 4a. The plurality of A in FIG. 8 indicates the distribution of actual determined values R of the probability of viewing the detailed information (expected click value 24g) at each distance L. In accordance with the statistical information of the actual determined value R, the expected click value CTR of the advertising information 4a at each distance L is estimated. Based this expected click value CTR, the ranking information H4 of the advertising information 4a is generated.

As described above, because the expected click value CTR is estimated in accordance with statistical information from the past, the accuracy of the estimation improves as the amount of accumulated statistical information increases, and the estimated value of the expected click value also changes due to changes in the statistical information.

The ranking information H (H4, H5) of the advertising information 4a, 5a may also be calculated in accordance with the following formula using this expected click value CTR and the abovementioned advertising rate CPC.

H=k2/(CPC×CTR) (wherein k2 is a coefficient). Herein, the smaller the value of ranking information H4, H5 that has been calculated for each piece of the advertising information 4a, 5a, the higher the priority that is set. Therefore, if the advertising range CPC, which changes depending on the distance L (Lp, Lm), is higher and the expected click value CTR is larger, the value of ranking information H of the advertising information becomes smaller and the priority is set to high. Thus, advertising information can be equitably provided and highly effective advertising for advertisers can be preferentially provided.

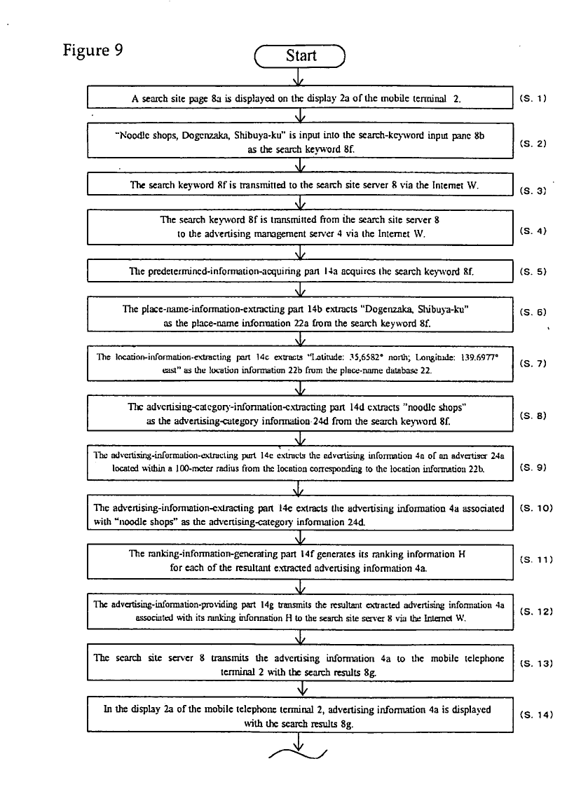

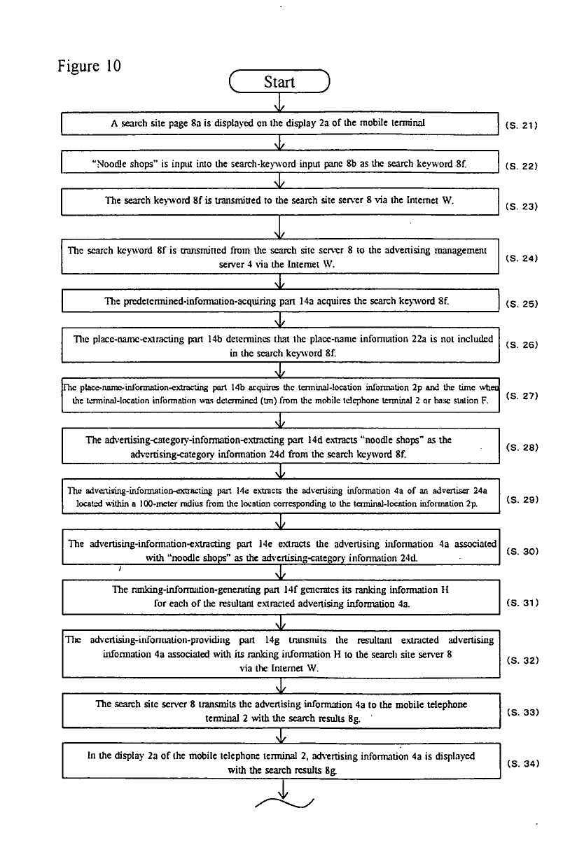

Next, a procedure for implementing the method of providing advertising information according to Embodiment 1 of the present invention will be described with reference to the flowcharts shown in FIG. 9 and FIG. 10. FIG. 9 describes a case when the place-name information 22a is included in the search keyword 8f and FIG. 10 describes a case when the place-name information 22a is not included in the search keyword 8f.

First, in FIG. 9, once a user accesses the search site server 8 from the mobile telephone terminal 2, a search site page 8a is displayed on the display 2a (S.1). When the user inputs “Noodle shops, Dogenzaka, Shibuya-ku” into the search-keyword input pane 8b on that search site page 8a as the search keyword 8f (S.2), the search keyword 8f is transmitted to the search site server 8 via the Internet W (S.3). Simultaneously, the search keyword 8f is transmitted from the search site server 8 to the advertising management server 4 via the Internet W (S.4).

In the advertising management server 4, the predetermined-information-acquiring part 14a acquires the search keyword 8f (S.5) while the place-name-extracting part 14b extracts “Dogenzaka, Shibuya-ku” as the place-name information 22a from the search keyword 8f (S.6). Based on “Dogenzaka, Shibuya-ku” as the place-name information 22a, the location-information-extracting part 14c extracts from the place-name database 22 “latitude: 35,6582° north; longitude: 139.6977° east” as the location information 22b that has been associated with “Dogenzaka, Shibuya-ku” (S.7). Furthermore, the advertising-category-information-extracting part 14d extracts “noodle shops” from the search keyword 8f as the advertising-category information 24d (S.8).

The advertising-information-extracting part 14e extracts the advertising information 4a of an advertiser 24a located within a 100-meter radius from the location corresponding to the location information 22b in accordance with “latitude: 35,6582° north; longitude: 139.6977° east” as the location information 22b (S.9). Specifically, the distance between the location corresponding to the location information 22b and the location corresponding to the whereabouts information 24c are calculated in accordance with the whereabouts information 24c and location information 22b, which have been associated with each piece of advertising information 4a in the advertising database 24, and the advertising information 4a is extracted if the distance is within 100 meters.

Furthermore, the advertising-information-extracting part 14e extracts advertising information 4a that has been associated with advertising-category information 24d of “noodle shops” in accordance with “noodle shops” as the advertising-category information 24d that has been extracted from the search keyword 8f (S.10). Specifically, all advertising-category information that has been associated with each piece of advertising information within the advertising database 24 is examined, and of them only advertising information 4a in which the advertising-category information 24d is “noodle shops” is extracted.

Of course, the advertising-information-extracting part 14e need not examine all advertising-category information of advertising information in the advertising database 24 and may examine only advertising-category information of advertising information that has been extracted as information in which the distance is within 100 meters. In addition, advertising-category information that has been associated with advertising information in the advertising database 24 is not always consistent with advertising-category information that has been extracted from the search keyword 8f, and, for example, when there is a certain level of correlation such as “noodle shops” and “restaurants” or “PCs” and “electronics stores”, relevant advertising information may be extracted.

The ranking-information-generating part 14f generates ranking information H for each of the resultant extracted advertising information 4a (i.e., advertising information 4a in which the advertising-category information 24d for “noodle shops” is selected from advertising information 4a of advertisers 24a located within 100 meters from the location corresponding to the location information 22b) (S.11). Ranking information is generated in accordance with at least any one of the advertising rate 24f, the expected click value 24g, and the distance Lp as described above.

The advertising-information-providing part 14g transmits the resultant extracted advertising information 4a associated with its ranking information H to the search site server 8 via the Internet W (S.12). The search site server 8 transmits the advertising information 4a that has been received from the advertising management server 4 to the mobile telephone terminal 2 together with the search results 8g of a search performed in accordance with the search keyword 8f (S.13).

In the display 2a of the mobile telephone terminal 2, while the search results 8g are displayed in the search-results display pane 8d of the search site 8a, the advertising information 4a is displayed in the advertising-information display pane 8d (S.14). At this time, the priorities of each piece of advertising information 4a are set in accordance with the ranking information H for each piece of advertising information 4a in the search site server 8 or in the mobile telephone terminal 2, and the advertising information 4a is displayed in accordance with the priorities.

Next, in FIG. 10, when a user accesses the search site server 8 from the mobile telephone terminal 2, the search site 8a is displayed on the display 2a (S.21). When the user inputs “noodle shops” into the search-keyword input pane 8b of the search site page 8a as the search keyword 8f (S.22), the search keyword 8f is transmitted to the search site server 8 via the Internet W (S.23). Simultaneously, the search keyword 8f is transmitted from the search site server 8 to the advertising management server 4 via the Internet W (S.24).

In the advertising management server 4, the predetermined-information-acquiring part 14a acquires the search keyword 8f (S.25). Subsequently, when the place-name information 22a is determined not to be included in the search keyword 8f (S.26), the place-name-extracting part 14b acquires from the mobile telephone terminal 2 or base station F the terminal-location information 2p that has been determined by the mobile telephone terminal 2 and GPS satellite 10 in advance along with the time when the terminal-location information is determined (tm) (the time at which the terminal-location information 2p will be determined) (S.27).

Furthermore, the advertising-category-information-extracting part 14d extracts “noodle shops” as the advertising-category information 24d from the search keyword 8f (S.28).

The advertising-information-extracting part 14e extracts the advertising information 4a of an advertiser 24a located within a 100-meter radius from the location corresponding to the terminal-location information 2p (S.29). Specifically, the distance between the location corresponding to the terminal-location information 2p and the location corresponding to the whereabouts information 24c are calculated in accordance with the whereabouts information 24c and terminal-location information 2p, which have been associated with each piece of advertising information 4a in the advertising database 24, and the advertising information 4a is extracted if the distance is within 100 meters.

Furthermore, the advertising-information-extracting part 14e extracts the advertising information 4a that have been associated with the advertising-category information 24d of “noodle shops” in accordance with “noodle shops” as the advertising-category information 24d that has been extracted from the search keyword 8f (S.30). Specifically, all advertising-category information that has been associated with each piece of advertising information in the advertising database 24 is examined, and of them only advertising information 4a in which the advertising-category information 24d is “noodle shops” is extracted.

Of course, the advertising-information-extracting part 14e need not examine all advertising-category information of advertising information in the advertising database 24 and may examine only advertising-category information of advertising information that has been extracted as information in which the distance is within 100 meters. In addition, advertising-category information that has been associated with advertising information in the advertising database 24 is not always consistent with advertising-category information that has been extracted from the search keyword 8f, and, for example, when there is a certain level of correlation such as “noodle shops” and “restaurants” or “PC” and “electronics stores”, relevant advertising information may be extracted.

The ranking-information-generating part 14f generates its ranking information H for each of the resultant extracted advertising information 4a (i.e., advertising information 4a in which the advertising-category information 24d for “noodle shops” is selected from the advertising information 4a of an advertiser 24a located within 100 meters from the location corresponding to the terminal-location information 2p) (S.31). Ranking information is generated in accordance with at least any one of the advertising rate 24f, expected click value 24g, distance Lm, and time difference T as described above.

The advertising-information-providing part 14g transmits the resultant extracted advertising information 4a associated with its ranking information H to the search site server 8 via the Internet W (S.32). The search site server 8 transmits the advertising information 4a that has been received from the advertising management server 4 to the mobile telephone terminal 2 together with the search results 8g of the search performed in accordance with the search keyword 8f (S.33).

In the display 2a of the mobile telephone terminal 2, while the search results 8g are displayed in the search-results display pane 8c of the search site page 8a, the advertising information 4a is displayed in the advertising-information display pane 8d (S.34). At this time, the priorities of each piece of advertising information 4a are set in accordance with the ranking information H for each piece of advertising information 4a in the search site server 8 or in the mobile telephone terminal 2, and the advertising information 4a is displayed in accordance with the priorities.

In addition, when failing to extract the location information 22b because the place-name information 22a is not included in the search keyword 8f, or when the advertiser 24a is not located within a predetermined range from the location corresponding to the location information 22b, it may be configured so that broad-ranging advertising information is provided to the mobile telephone terminal 2.

Broad-ranging advertising information is advertising information that is not selected in accordance with location information and includes, for example, advertising information of national chain stores and advertising information of various products and companies. In the event that the location information 22b is not extracted, a certain level of advertising effectiveness can be expected and advertising information can be useful for users if the advertising information is regarding national chain stores.

Therefore, the advertising-information display pane 8d on the display 2a can be fully and effectively utilized by providing broad-ranging advertising information to the mobile telephone terminal 2.

### Embodiment 2

The method of providing advertising information according to Embodiment 2 of the present invention will be described with reference to the drawings. In addition, in Embodiment 2, the descriptions of configurations identical to those in Embodiment 1 will be omitted with the use of identical reference numerals.

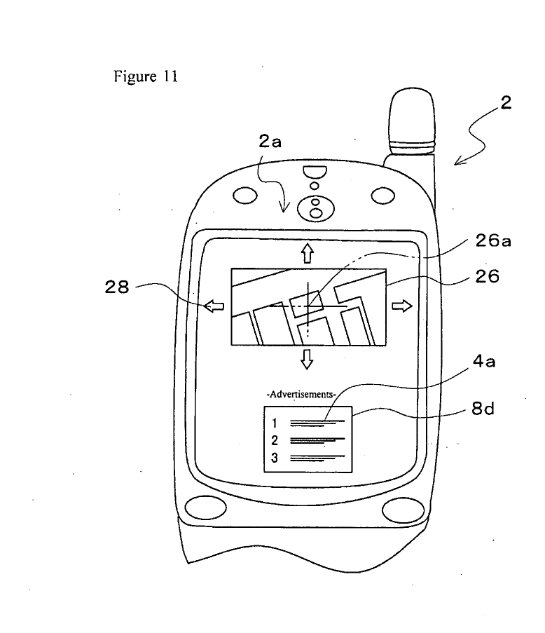

FIG. 11 is a diagram illustrating a state in which a map 26 is displayed on the display 2a of the mobile telephone terminal 2. In Embodiment 2 of the present invention, the map 26 is displayed on the display 2a through the operation of the user. As an example scenario of the user displaying the map 26 on the display 2a, the user displays a map of the vicinity of a restaurant on the display 2a to check the direction to the restaurant that the user plans to visit.

Therefore, the area displayed on the map 26 is an area displayed through the operation of the user, meaning that it can be an area that the user is interested in (area of interest).

The location-information-extracting part 14c extracts information for “Shibuya-ku” as the location information 22b of a center location 26a of the map 26 when the map 26 is displayed on the display 2a.

The advertising-information-extracting part 14e includes a function of extracting the advertising information 4a of an advertiser 24a located within a predetermined range from the advertising database 24 while using the location corresponding to “Shibuya-ku”, which has been extracted as the location information 22b, as a base point. Herein, the predetermined range of Embodiment 2 is one in which the range is within the same administrative unit as the location corresponding to the location information 22b.

In other words, the location (administrative unit) corresponding to “latitude: 35.6582° north; longitude: 139.6977° east” that has been extracted as the location information 22b is “Shibuya-ku”, and the advertising information 4a of an advertiser 24a in which the same administrative unit of “Shibuya-ku” is regarded as the whereabouts information 24c and is extracted from the advertising database 24. In addition, the administrative unit that defines the predetermined range may be a prefectural unit (e.g., “Tokyo”).

The ranking-information-generating part 14f generates the ranking information H for each piece of advertising information 4a, indicating the priority when the extracted advertising information 4a is displayed on the display 2a of the mobile telephone terminal 2, but the method of generation is the same as that described in Embodiment 1 and the description will be omitted.

Also, as in Embodiment 1, higher-priority advertising information 4a is displayed in a higher order of priority in the mobile telephone terminal 2 in accordance with the generated ranking information H.

When a user selects an arrow 28 displayed around the map 26, the area displayed on the map 26 moves in the direction of the arrow to display a new area on the map 26. The location-information-extracting part 14c extracts again the location information 22b of the center location 26a of the map 26 that has been newly displayed.

Therefore, even if a user is interested in a different area from the map 26 that has been originally displayed and the different area is displayed, advertising information 4a in accordance with the location information 22b of the new area of interest can still be extracted and displayed on the display 2a.

The preferred embodiments of the present invention have been described above, but the present invention is not limited to these embodiments and various variations and modifications can be made within the scope of the invention.

What is claimed as new and is desired to be secured by Letters Patent of the United States is:

1. A method of providing advertising information to a communication terminal, the method comprising:
acquiring location information from the communication terminal;
extracting advertising information of advertisers which locate within a predetermined range from a base point corresponding to the location information; and
providing the extracted advertising information to said communication terminal.

2. The method of providing advertising information according to claim 1, wherein the step of acquiring location information comprises
acquiring predetermined information that has been input through said communication terminal,
extracting place-name information from the predetermined information; and
extracting location information associated with the place-name information.

3. The method of providing advertising information according to claim 2, further comprising:
extracting advertising-category information from said predetermined information; and
extracting advertising information associated with the extracted advertising-category information.

4. The method of providing advertising information according to claim 1, wherein the location information represents a location of said communication terminal.

5. The method of providing advertising information according to claim 1, wherein said predetermined range is determined in accordance with administrative units.

6. The method of providing advertising information according to claim 1, further comprising:
generating ranking information in accordance with at least one of
a distance from the location that corresponds to the location information,
an advertising rate that has been predetermined for each piece of said advertising information, and
an expected click value indicating the probability that detailed information of the advertising information will be viewed through the communication terminal when said advertising information is provided to said communication terminal,
wherein the extracted advertising information is provided to said communication terminal in accordance with said ranking information.

7. The method of providing advertising information according to claim 6, wherein said ranking information is calculated in accordance with the following formula:
H=k/(CPC×CTR)
wherein
H: ranking information,
k: coefficient,
CPC: advertising rate determined by each piece of advertising information, and
CTR: expected click value for advertising information.

8. The method of providing advertising information according to claim 4, further comprising:
generating ranking information in accordance with at least one of
a distance from the location that corresponds to the location information, and
time when the location information is acquired,
wherein the extracted advertising information is provided to said communication terminal in accordance with said ranking information.

9. The method of providing advertising information according to claim 8, wherein said ranking information is calculated in accordance with the following formula:
H=k×T×L
wherein
H: ranking information,
k: coefficient,
T: time difference between the time when the location information of the communication terminal is acquired and the time when the advertising information is provided to the communication terminal, and
L: distance.

10. A system for providing advertising information, comprising:
a place-name database constructed by associating place-name information with location information that indicates a specific place corresponding to the place-name information;
an advertising database constructed by associating advertising information with location of an advertiser that corresponds to the advertising information;
a predetermined-information-acquiring part configured to acquire predetermined information that has been input through a communication terminal;
a place-name-extracting part configured to extract said place-name information from the predetermined information;
a location-information-extracting part configured to extract from said place-name database said location information that has been associated with said place-name information;
an advertising-information-extracting part configured to extract from the advertising database said advertising information of the advertiser located within a predetermined range from a base point corresponding to the location information; and
an advertising-information-providing part configured to provide the extracted advertising information to said communication terminal.

11. A program for providing advertising information causing a computer to function as:
a predetermined-information-acquiring part that acquires predetermined information that has been input through a communication terminal,
a place-name-extracting part that extracts place-name information from the predetermined information,
a location-information-extracting part that extracts location information that has been associated with the place-name information,
an advertising-information-extracting part that extracts advertising information of the advertiser located within a predetermined range while using the location corresponding to the location information as a base point of the predetermined range; and
an advertising-information-providing part that provides the extracted advertising information to said communication terminal.
